(19) United States
(12) Patent Application Publication
(10) Pub. No.: US 2007/0111802 A1
(43) Pub. Date: May 17, 2007

(54) Video game system, video game program, and video game device

(75) Inventors: Tsunekazu Ishihara, Chiyoda-ku (JP); Seiichiro Nagahata, Setagaya-Ku (JP)

Correspondence Address: NIXON & VANDERHYE, P.C., 901 NORTH GLEBE ROAD, 11TH FLOOR, ARLINGTON, VA, 22203, US

(73) Assignee: Nintendo Co.,Ltd. The Pokemon Company and CHUNSOFT Co., Ltd., Tokyo (JP)

(21) Appl. No.: 11/477,661

(22) Filed: Jun. 30, 2006

(30) Foreign Application Priority Data
Nov. 16, 2005 (JP) 2005-332050

(51) Int. Cl. A63F 13/00

(52) U.S. Cl. 463/43

(57) ABSTRACT

A video game device 10 is capable of receiving both a first storage medium and a second storage medium at the same time. The video game device 10 performs a first game process using first save data. The video game device 10 performs a second game process using second save data. The video game device 10 overwrites the first save data based on the status of the second video game. The video game device 10 overwrites the second save data based on the status of the first video game.

### CROSS REFERENCE TO RELATED APPLICATION

The disclosure of Japanese Patent Application No. 2005-332050 is incorporated herein by reference.

### BACKGROUND OF THE INVENTION

1. Field of the Invention

The present invention relates to a video game system and, more particularly, to a video game system including a video game device that can receive two storage media at the same time.

2. Description of the Background Art

There is a conventional approach for video game devices that can receive two storage media at the same time, in which data of one storage medium is used while executing a video game program stored in the other storage medium (see, for example, Non-Patent Document 1 (“Nintendo DREAM vol. 125”, Mainichi Communications Inc., Dec. 21, 2004, p. 15) and Non-Patent Document 2 (“Dengeki Gamecube, January 2005 issue”, Mediaworks Inc., Jan. 1, 2005, p. 15)). In this approach, when two storage media are received in a video game device at the same time, a new map is displayed, which is not displayed when only one storage medium is received therein.

Specifically, the save memory in the first game cartridge stores character information collected as the video game is played. In the other, second game cartridge, different special map data are stored in advance, which are associated with different characters, which can be collected in the video game of the first game cartridge (the first video game). When the video game of the second game cartridge (the second video game) is executed while both game cartridges are being received in the video game device at the same time, the use of special map data associated with the character stored in the first game cartridge is allowed. Thus, the player can play a game with a special map for the character. Therefore, the player can enjoy various game scenarios as the game scenario of the game of one game cartridge is varied by using the save data of the other game cartridge.

However, the effect of this conventional approach is to merely change the game map of the second video game according to the save data of the first video game. Thus, the game scenario or the advancement status of the second video game are not at all reflected in the first video game, and how the first video game is played is therefore not different at all from that in a normal mode. Thus, in the conventional approach, the two video games do not fully interact with each other, and the interaction therebetween is rather weak. Therefore, playing both the first video game and the second video game does not give a combined effect.

### SUMMARY OF THE INVENTION

Therefore, an object of the present invention is to provide a video game system using a video game device that can receive two storage media at the same time, wherein two games can be associated with each other.

The present invention has the following features to attain the object mentioned above. Note that parenthetic expressions in the following section (reference numerals, supplementary explanations, etc.) are merely to indicate the correlation between what is described in the following section and what is described in the description of the preferred embodiments set out further below in the present specification, and are in no way intended to restrict the scope of the present invention.

A first aspect of the present invention is directed to a video game system, including a first storage medium (the memory card 17), a second storage medium (the cartridge 18), and a video game device (10) capable of receiving both the first storage medium and the second storage medium at the same time. The first storage medium includes: first program storage means (the ROM 17a) and first save data storage means (the flash memory 17b). The first program storage means is means for pre-storing a first video game program used for performing a first game process. The first save data storage means is means for storing first save data (FIG. 6) regarding a first video game played by performing the first game process. The second storage medium includes second program storage means (the ROM 18a) and second save data storage means (the flash memory 18b). The second program storage means is means for pre-storing a second video game program used for performing a second game process. The second save data storage means is means for storing second save data regarding a second video game played by performing the second game process. The video game device includes first game process means (the first CPU core 21 performing step S55), second game process means (the second CPU core 22 performing step S56), first overwriting means (the first CPU core 21 performing S83 or S93), and second overwriting means (the first CPU core 21 or the second CPU core 22 performing S67 or S69). The first game process means is means for performing the first game process using the first save data. The second game process means is means for performing the second game process using the second save data. The first overwriting means is means for overwriting the first save data (the rescue status data 51 or the rescuee status data 57) based on a status of the second video game (the second player character having been defeated by an enemy character, or the second player character having rescued the first player character). The second overwriting means is means for overwriting the second save data (the rescue status data 71 or the rescuee status data 77) based on a status of the first video game (the first player character having been defeated by an enemy character, or the first player character having rescued the second player character).

In a second aspect, the video game device may further include third overwriting means (the first CPU core 21 performing S107). The third overwriting means is means for overwriting the first save data (the rescuee status data 57) when the status of the first video game becomes equal to a predetermined first state (the first player character having been defeated by an enemy character) to thereby indicate that the game status is equal to the first state. The second game process means performs a predetermined game process for playing a game whose object is to satisfy a predetermined first condition regarding the status of the second video game (the second player character having rescued the first player character) when the status of the first video game becomes equal to the first state. The first overwriting means overwrites the first save data to indicate that the game status has been restored from the first state when the first condition is satisfied.

In a third aspect, the video game device may further include fourth overwriting means (the second CPU core 22 performing S119). The fourth overwriting means is means for overwriting the second save data (the rescuee status data 77) when the status of the second video game becomes equal to a predetermined second state (the second player character having been defeated by an enemy character) to thereby indicate that the game status is equal to the second state. The first game process means performs a predetermined game process for playing a game whose object is to satisfy a predetermined second condition regarding the status of the first video game (the first player character having rescued the second player character) when the status of the second video game becomes equal to the second state. The second overwriting means overwrites the second save data to indicate that the game status has been restored from the second state when the second condition is satisfied.

In a fourth aspect, the video game device may further include fifth overwriting means (the second CPU core 22 performing S119 or S124). The fifth overwriting means is means for writing data representing the status of the second video game at a predetermined point in time to second save data storage means as the second save data while the second game process is being performed. The first overwriting means overwrites the first save data based on the second save data while the first game process is being performed.

In a fifth aspect, the video game device may further include overwrite selection means (the first CPU core 21 performing S63 and S70 or S65 and S68). The overwrite selection means selects, according to a user's operation, whether or not to perform the overwriting operation by the first overwriting means or the second overwriting means.

In a sixth aspect, the video game device may further include game selection means (the first CPU core 21 performing S53 and S54). The game selection means is means for selecting, according to a player's operation, whether to play the first video game or the second video game. The first game process means performs the first game process by executing the first video game program when the first video game is selected by the game selection means. The second game process means performs the second game process by executing the second video game program when the second video game is selected by the game selection means.

In a seventh aspect, one of the first storage medium and the second storage medium can be inserted in another video game device, which cannot receive the other one of the first storage medium and the second storage medium.

An eighth aspect of the present invention is directed to a video game device (10) capable of receiving both a first storage medium (the memory card 17) and a second storage medium (the cartridge 18) at the same time. The first storage medium includes first program storage means (the ROM 17a) and first save data storage means (the flash memory 17b). The first program storage means is means for pre-storing a first video game program used for performing a first game process. The first save data storage means is means for storing first save data (FIG. 6) regarding a first video game played by performing the first game process. The second storage medium includes second program storage means (the ROM 18a) and second save data storage means (the flash memory 18b). The second program storage means is means for pre-storing a second video game program used for performing a second game process. The second save data storage means is means for storing second save data (FIG. 7) regarding a second video game played by performing the second game process. The video game device includes first game process means (the first CPU core 21 performing step S55), second game process means (the second CPU core 22 performing step S56), first overwriting means (the first CPU core 21 performing S83 or S93), and second overwriting means (the first CPU core 21 or the second CPU core 22 performing S67 or S69). The first game process means is means for performing the first game process using the first save data. The second game process means is means for performing the second game process using the second save data. The first overwriting means is means for overwriting the first save data (the rescue status data 51 or the rescuee status data 57) based on a status of the second video game (the second player character having been defeated by an enemy character, or the second player character having rescued the first player character). The second overwriting means is means for overwriting the second save data (the rescue status data 71 or the rescuee status data 77) based on a status of the first video game (the first player character having been defeated by an enemy character, or the first player character having rescued the second player character).

A ninth aspect of the present invention is directed to a storage medium storing a video game program to be executed by a computer (the first CPU core 21) of a video game device (10) for performing a first game process. The video game device is capable of receiving both the storage medium (the memory card 17) and another storage medium (the cartridge 18) at the same time. The storage medium includes first program storage means (the ROM 17a) and first save data storage means (the flash memory 17b). The first program storage means is means for pre-storing a first video game program used for performing a first game process. The first save data storage means is means for storing first save data (FIG. 6) regarding a first video game played by performing the first game process. The other storage medium includes second program storage means (the ROM 18a) and second save data storage means (the flash memory 18b). The second program storage means is means for pre-storing another video game program used for performing a second game process. The second save data storage means is means for storing second save data (FIG. 7) regarding a second video game played by performing the second game process. The video game device includes second game process means (the second CPU core 22). The video game program instructs the computer to perform a first game process step (S72), a first overwriting step (S83 or S93), and a second overwriting step (S67 or S69). The first game process step is a step of performing the first game process using the first save data. The first overwriting step is a step of overwriting the first save data based on a status of the second video game. The second overwriting step is a step for overwriting the second save data based on a status of the first video game.

According to the first aspect, the first and second overwriting means are provided, whereby the save data of one of two games stored in two different storage media is changed according to the status of the other one of the two games. The game process is performed by the first and second game process means using the save data. Thus, one game is played while reflecting the status of the other game, whereby the games can be associated with each other. Therefore, it is possible to realize a video game with improved playability, in which how one game progresses is varied according to the results of playing the other game. In this aspect, the statuses of two games influence each other, whereby the two games can be associated with each other. This gives a wider variety of game scenarios of the two games, thereby improving the game playability.

According to the second aspect, where the status of the first video game has become equal to a predetermined first state, the game status can be restored from the first state in the first video game by satisfying a predetermined first condition in the second game. Where the player intends to restore the game status from the first state (e.g., the player having been defeated by an enemy character), the first video game can be played more advantageously by playing the second game. Thus, according to the second aspect, there is added a novel option for a player of a video game, i.e., “to play a second video game being different from a first video game” in order to complete the first video game. This improves the strategic aspect of the video game, whereby it is possible to provide a novel video game with high playability.

According to the third aspect, it is possible to improve the strategic aspect of the video game, whereby it is possible to provide a novel video game with high playability, as in the second aspect of the present invention.

According to the fourth aspect, even in a case where there is a limitation on the video game device that the second save data can be overwritten only when the first video game program is being executed, the first save data can be overwritten based on the status of the second video game.

According to the fifth aspect, the player can select whether or not to overwrite each save data by the corresponding overwriting means.

According to the sixth aspect, where two storage media are both inserted in the video game device, the player can select the storage medium to be used to play the game.

According to the seventh aspect, two video games for different types (models) of video game devices can be made compatible with each other, while the contents of the two games can be associated with each other.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows an external view of a video game device and first and second game cartridges included in the video game system of the present invention;

FIG. 2 shows an internal configuration of the video game device of FIG. 1;

FIG. 3 shows an exemplary game screen in one embodiment of the present invention;

FIG. 4 shows the flow of a game process where the first player character rescues the second player character;

FIG. 5 shows the flow of a game process where the second player character rescues the first player character;

FIG. 6 shows first save data stored in a memory card 17;

FIG. 7 shows second save data stored in a cartridge 18;

FIG. 8 is a main flow chart showing the flow of a game process performed by a video game device 10;

FIG. 9 is a flow chart showing the detailed flow of step S55 shown in FIG. 8;

FIG. 10 is a flow chart showing the detailed flow of step S64 shown in FIG. 9;

FIG. 11 is a flow chart showing the detailed flow of step S71 shown in FIG. 9;

FIG. 12 is a flow chart showing the detailed flow of step S72 shown in FIG. 9;

FIG. 13 is a flow chart showing the detailed flow of step S56 shown in FIG. 8; and

FIG. 14 is a flow chart showing the detailed flow of step S120 shown in FIG. 13.

### DESCRIPTION OF THE PREFERRED EMBODIMENTS

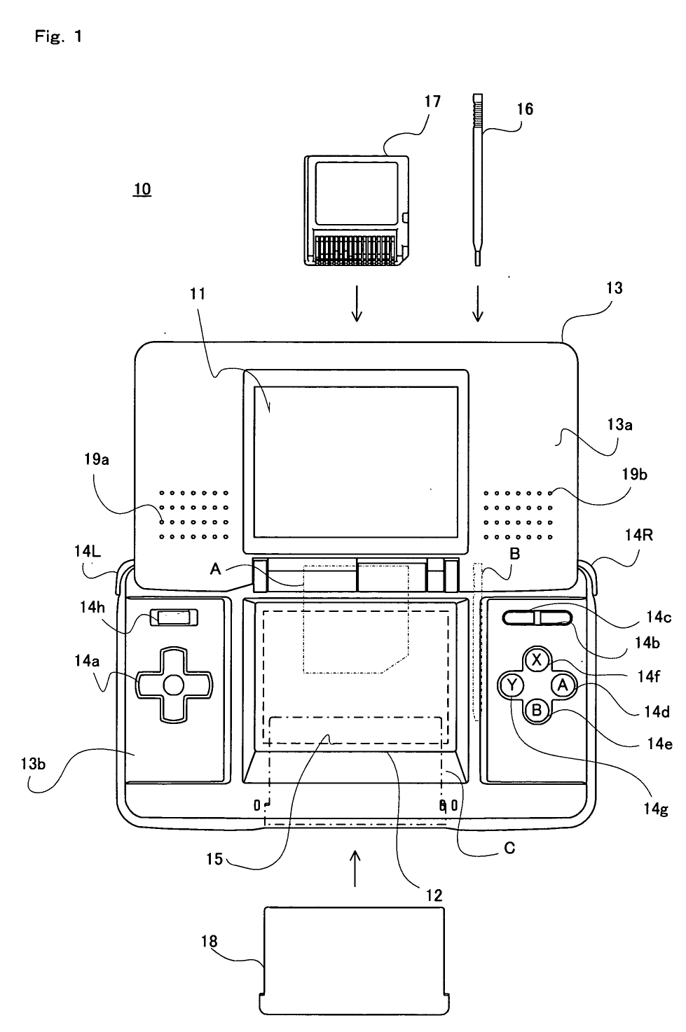

A configuration of a video game device 10 included in a video game system according to an embodiment of the present invention will now be described with reference to the drawings. FIG. 1 shows an external view of the video game device 10 included in the video game system, and a memory card 17 and a cartridge 18 to be received in the video game device 10. The configuration and the operation of the video game device 10 will now be described.

Referring to FIG. 1, the video game device 10 includes a first LCD (Liquid Crystal Display) 11 and a second LCD 12. A housing 13 includes an upper housing 13a accommodating the first LCD 11, and a lower housing 13b accommodating the second LCD 12. The first LCD 11 and the second LCD 12 both have a resolution of 256×192 dots. While LCDs are used in the present embodiment, the display device may be of any other suitable type, e.g., an EL (Electro Luminescence) display device. Moreover, the resolution of the first LCD 11 and the second LCD 12 is not limited to the particular resolution used herein.

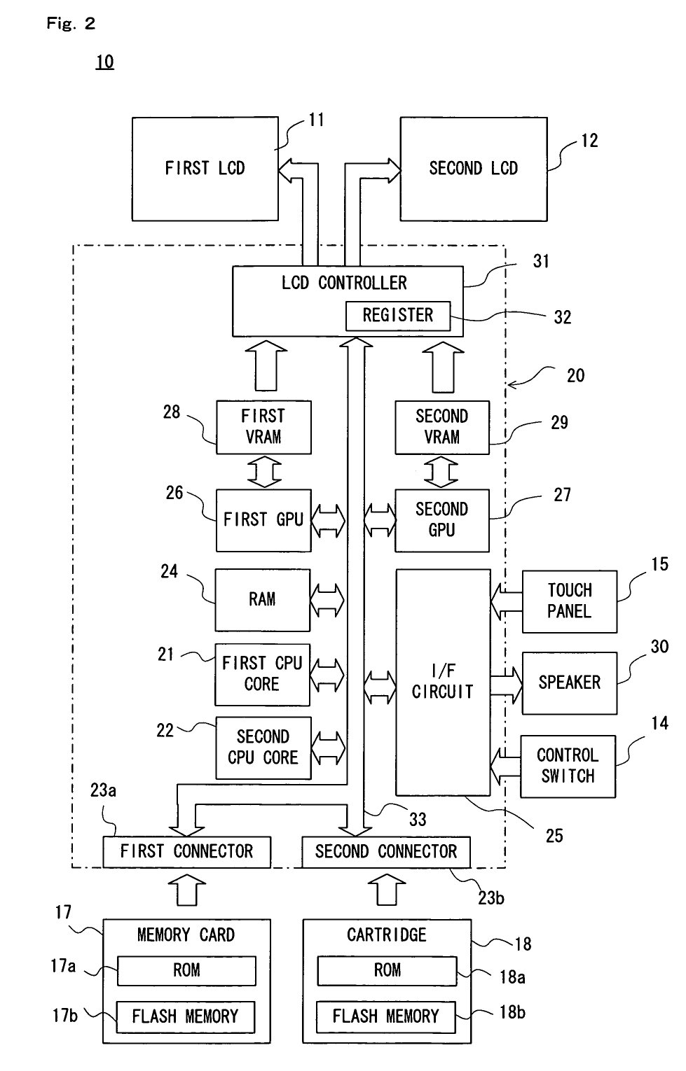

The upper housing 13a includes sound slits 19a and 19b therein for allowing the sound from a pair of speakers (30 in FIG. 2) to be described later to pass therethrough.

The lower housing 13b includes a set of input devices, including a cross-shaped switch 14a, a start switch 14b, a select switch 14c, an A button 14d, a B button 14e, an X button 14f, a Y button 14g, a power switch 14h, an L button 14L and an R button 14R. Another input device is a touch panel 15 attached on the screen of the second LCD 12. The lower housing 13b includes a slot A for receiving the memory card 17, a slot B for receiving a stylus 16, and a slot C for receiving the cartridge 18.

The touch panel 15 may be any of various types of touch-sensitive panels, including a resistive film touch panel, an optical (infrared) touch panel and a capacitance-coupling touch panel. The touch panel 15 is capable of outputting position data corresponding to the contact point on the surface thereof, at which it is being touched with the stylus 16. While it is assumed herein that the player uses the stylus 16 to operate the touch panel 15, it is understood that the touch panel 15 may be operated with a pen (stylus pen) or a fingertip instead of the stylus 16. In the present embodiment, the touch panel 15 has a resolution (detection precision) of 256×192 dots, which is equal to the resolution of the second LCD 12. Note however that it is not necessary that the resolution of the touch panel 15 is equal to that of the second LCD 12.

The memory card 17 is a storage medium storing a first video game program for a first video game to be executed by the video game device 10, and is received by the slot A in the lower housing 13b. Although not shown in FIG. 1, a first connector 23a (see FIG. 2) is provided at the bottom of the slot A, which is to be in contact with a connector (not shown) provided at the tip (in the direction of insertion) of the memory card 17. When the memory card 17 is inserted in the slot A, the connectors are brought into contact with each other, whereby a first CPU core 21 (see FIG. 2) of the video game device 10 can access the memory card 17.

The cartridge 18 is a storage medium storing a second video game program for a second video game to be executed by the video game device 10, and is received by the slot C in the lower housing 13b. Although not shown in FIG. 1, a second connector 23b (see FIG. 2) is provided at the bottom of the slot C, which is to be in contact with a connector (not shown) provided at the tip (in the direction of insertion) of the cartridge 18. When the cartridge 18 is inserted in the slot C, the connectors are brought into contact with each other, whereby a second CPU core 22 (see FIG. 2) of the video game device 10 can access the cartridge 18.

Referring now to FIG. 2, an internal configuration of the video game device 10 will be described. Referring to FIG. 2, the first CPU core 21 and the second CPU core 22 are mounted on an electronic circuit board 20 accommodated in the housing 13. The first and second CPU cores 21 and 22 are connected to the connectors 23a and 23b, an input/output interface circuit (referred to simply as an “I/F circuit”) 25, a first GPU (Graphics Processing Unit) 26, a second GPU 27, a RAM 24 and an LCD controller 31, via a bus 33. When only the cartridge 18 is inserted in the video game device 10, the second CPU core 22 operates to execute the game of the cartridge 18. When only the memory card 17 is inserted in the video game device 10 or when both the memory card 17 and the cartridge 18 are inserted at the same time therein, the first CPU core 21 operates as the main CPU and the second CPU core 22 as the sub-CPU.

The first connector 23a can receive the memory card 17 as described above. The memory card 17 includes a ROM 17a such as a mask ROM and a flash memory 17b. Although not shown in the figure, the ROM 17a and the flash memory 17b are connected to each other via a bus, and are further connected to a connector (not shown) to be in contact with the first connector 23a. Therefore, the first CPU core 21 can access the ROM 17a and the flash memory 17b.

The second connector 23b can receive the cartridge 18 as described above. The cartridge 18 includes a ROM 18a such as a mask ROM and a flash memory 18b. Although not shown in the figure, the ROM 18a and the flash memory 18b are connected to each other via a bus, and are further connected to a connector (not shown) to be in contact with the second connector 23b. Therefore, the first CPU core 21 and the second CPU core 22 can access the ROM 18a and the flash memory 18b.

In addition to the first video game program, the ROM 17a of the memory card 17 pre-stores image data used in the game process of the first video game (image data of character images, object images, background images, item images, icon (button) images, message images, cursor images, various screen images, etc.), sound data for producing a sound needed for the first video game (music, BGM, sound effects, etc.), and other data.

The flash memory 17b of the memory card 17 is a non-volatile memory where data can be written/erased, i.e., a re-writable non-volatile memory. The flash memory 17b stores save data representing the current status of a game or a game result. In the illustrated example, the save data of the first video game (the first save data) is stored in the flash memory 17b of the memory card 17.

In addition to the second video game program, the ROM 18a of the cartridge 18 pre-stores image data used in the game process of the second video game, sound data for producing a sound needed for the second video game, and other data. The flash memory 18b of the cartridge 18 is a non-volatile memory where data can be written/erased, i.e., a re-writable non-volatile memory. The save data of the second video game (the second save data) is stored in the flash memory 18b.

In other embodiments, the flash memories 17b and 18b may be replaced by other types of non-volatile memories, such as SRAMs powered by a backup battery, EEPROMs and FeRAMs.

In the present embodiment, the memory card 17 and the cartridge 18 are accessible while the first video game program is being executed, whereas only the cartridge 18 is accessible while the second video game program is being executed. Therefore, the save data of the memory card 17 and that of the cartridge 18 can be read/written while the first video game program is being executed, whereas only the save data of the cartridge 18 can be read/written while the second video game program is being executed.

When the first video game program is executed in the video game device 10, the first video game program stored in the ROM 17a of the memory card 17 is loaded to the RAM 24, and the loaded first video game program in the RAM 24 is executed by the first CPU core 21. The entire first video game program may be loaded at once, or portions thereof may be loaded one after another as necessary. In addition to the first video game program, the RAM 24 also stores temporary data produced while the first CPU core 21 is running the video game program, and other data for producing game images.

When the second video game program is executed in the video game device 10, the second video game program stored in the ROM 18a of the cartridge 18 is loaded to the RAM 24, and the loaded second video game program in the RAM 24 is executed by the second CPU core 22. The entire second video game program may be loaded at once, or portions thereof may be loaded one after another as necessary. In addition to the second video game program, the RAM 24 also stores temporary data produced while the second CPU core 22 is running the video game program, and other data for producing game images.

The I/F circuit 25 is connected to the touch panel 15, speakers 30, and a control switch section 14 of FIG. 1 including the cross-shaped switch 14a, the A button 14d, etc. The two speakers 30 are provided inside the video game device 10, one behind the sound slit 19a and another behind the sound slit 19b.

A first VRAM (Video RAM) 28 is connected to the first GPU 26, and a second VRAM 29 is connected to the second GPU 27. In response to an instruction from the first CPU core 21 or the second CPU core 22, the first GPU 26 produces a first game image and renders it on the first VRAM 28, based on data stored in the RAM 24 for producing game images. Similarly, the second GPU 27 produces a second game image and renders it on the second VRAM 29 in response to an instruction from the first CPU core 21. The first VRAM 28 and the second VRAM 29 are connected to the LCD controller 31.

The LCD controller 31 includes a register 32. The register 32 stores a value of 0 or 1 in response to an instruction from the first CPU core 21 or the second CPU core 22. When the value stored in the register 32 is 0, the LCD controller 31 outputs the first game image rendered on the first VRAM 28 to the first LCD 11 and outputs the second game image rendered on the second VRAM 29 to the second LCD 12. When the value stored in the register 32 is 1, the LCD controller 31 outputs the first game image rendered on the first VRAM 28 to the second LCD 12 and outputs the second game image rendered on the second VRAM 29 to the first LCD 11.

The configuration of the video game device 10 described above is merely an example, and the present invention is applicable to any computer system that can, at the same time, receive two storage media each storing a video game program. While the video game device 10 includes two display devices (the first LCD 11 and the second LCD 12) in the description above, it may be any video game device that includes, or is connected to, at least one display device. While the video game device 10 includes the touch panel 15 in the description above, the video game device 10 may include any other suitable input means via which a user's operation can be received.

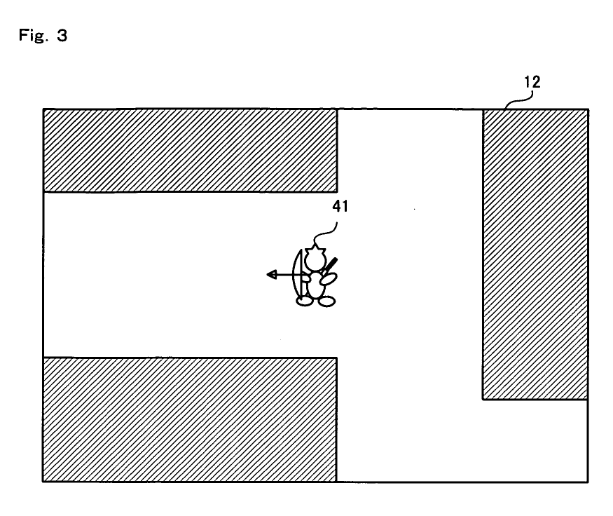

A video game to be played on the video game device 10 in the present embodiment will now be described. In the present embodiment, the first video game, which can be played by executing the first video game program stored in the memory card 17, and the second video game, which can be played by executing the second video game program stored in the cartridge 18, are played on the video game device 10. In the present invention, the first video game and the second video game are of the same or similar genre. For example, they may each be a roll playing game in which a player character 41 explores a multi-level dungeon, as shown in FIG. 3. It is herein assumed that the first video game and the second video game share the same player character (a character controlled by the player), the same enemy characters and the same items. However, there may be some characters and items that appear only in one game. There are a plurality of dungeons in the game world of the first video game, and the same dungeons as those in the game world of the first video game are present in the game world of the second video game. The first video game and the second video game are the same in that respect, and they can be said to be games of the same genre.

In the first video game or the second video game, the player controls the player character to explore a dungeon while defeating enemy characters, aiming at finally realizing a predetermined object (e.g., defeating a boss character, or finding treasure). The player character has a game parameter representing the hit point value, which decreases when the player character is attacked by an enemy character. When the hit point value of the player character becomes 0, it is determined that the game is over, and the player character is placed back to the start position of the dungeon. In other words, if the player character is defeated by an enemy character, the player needs to start all over from the beginning of the dungeon.

In the present embodiment, even if a player character is defeated by an enemy character in the first video game, the player character of the first video game can be rescued in the second video game. Similarly, even if a player character is defeated by an enemy character in the second video game, the player character of the second video game can be rescued in the first video game. Specifically, after a player character is defeated at a position in a dungeon in one game, a player character in the other game can rescue the defeated player character by reaching the position at which the player character was defeated. Then, the rescued player character can re-start from that position of the dungeon, instead of having to start all over from the start position of the dungeon. Thus, in the present embodiment, when a player character is defeated in one game, the game can be resumed more advantageously than normally if a predetermined condition (the defeated player character be rescued) is satisfied in the other game.

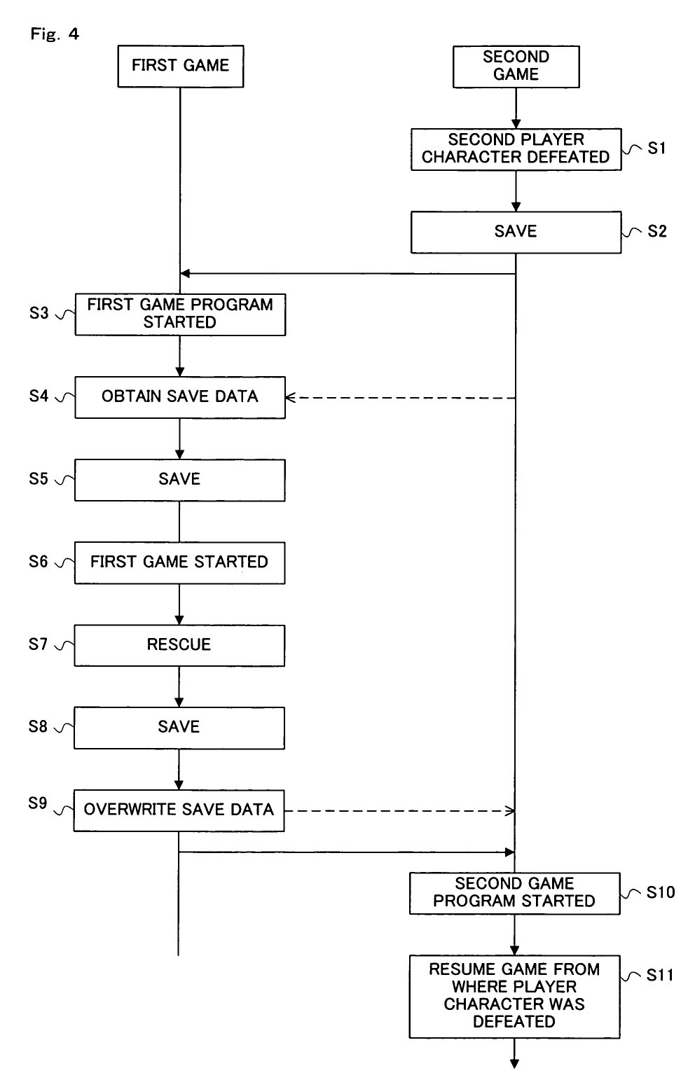

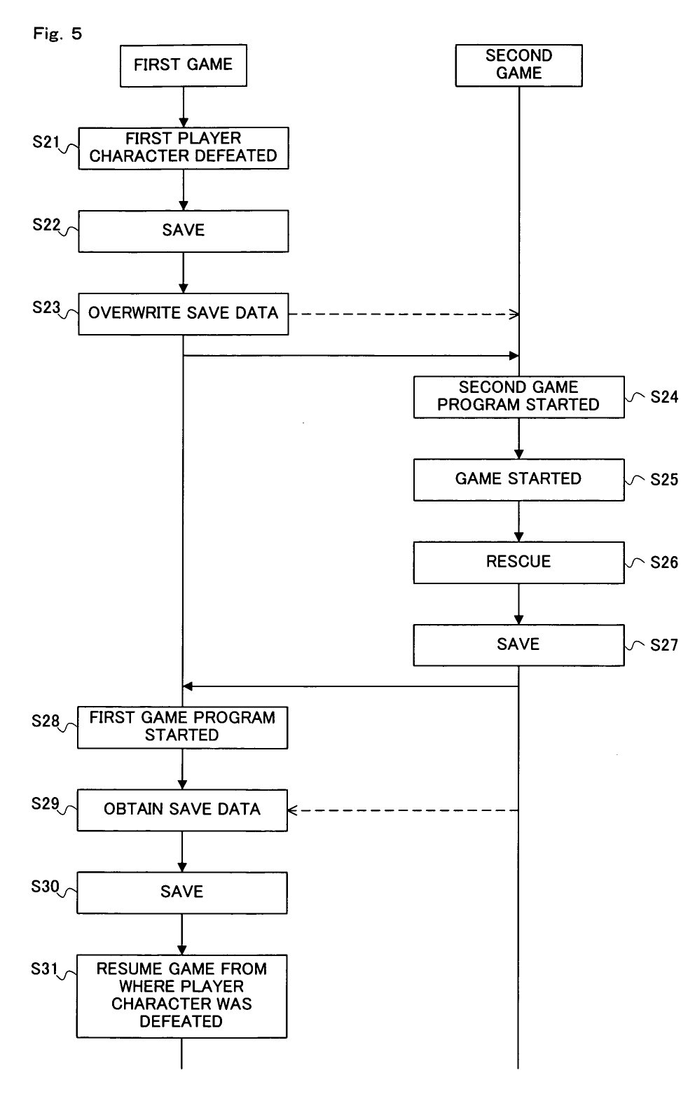

Referring now to FIGS. 4 and 5, the general flow of the game process in the present embodiment will be described. FIG. 4 shows the flow of the game process where the player character of the first video game (the first player character) rescues the player character of the second video game (the second player character). In FIG. 4, the process of the first video game (the first game process) is shown along the vertical line on the left, and the process of the second video game (the second game process) is shown along the vertical line on the right.

Referring to FIG. 4, first, the video game device 10 is executing the second video game program, and the player is playing the second video game. Then, the second player character is defeated by an enemy character (step S1). If the player chooses to have the first player character rescue the second player character in the first video game (i.e., to request a rescue by the first player character), the video game device 10 saves, in the cartridge 18, the status of the game at the point in time when the second player character was defeated by the enemy character (step S2).

The second save data representing the status of the second video game includes data (the rescuee status data) indicating whether or not the second player character needs to be rescued. In step S2, the rescuee status data is overwritten to “to be rescued (a state where the character needs to be rescued)”. Where the rescuee status data indicates “to be rescued”, the player cannot play the second video game before the rescue is completed in the first video game. After the save is completed, the video game device 10 once exits the second game process.

After step S2, the player chooses to play the first video game, in response to which the video game device 10 starts executing the first video game program (step S3). After the video game device 10 starts executing the first video game program, the video game device 10 first reads out the second save data from the cartridge 18, and detects the status of the second video game (step S4). Specifically, the video game device 10 obtains the rescuee status data included in the second save data.

Then, the video game device 10 overwrites the first save data according to the status of the second video game detected in step S4 (step S5). In the present embodiment, the first save data includes data (the rescue status data) indicating whether or not it is possible for the first player character to rescue the second player character. In step S4, the rescuee status data included in the second save data indicates “to be rescued”. Therefore, in step S5, the rescue status data is overwritten to “rescuable” according to the rescuee status data. Then, the player can play the first video game with the object being to rescue the second player character.

After step S5, the first video game is started (step S6). Specifically, a marker (e.g., a flag) is displayed at a position in the dungeon where the second player character has been defeated. In order to rescue the second player character, the player controls the first player character so that the first player character reaches the position of the marker. The first player character arriving at the position of the marker means that the rescue of the second player character is completed (step S7).

After the rescue of the second player character is completed, the video game device 10 saves, in the memory card 17, the status of the first video game at the point in time when the rescue is completed (step S8). Then, the video game device 10 overwrites the second save data stored in the cartridge 18 according to the status of the first video game (step S9). Specifically, since the rescue of the second player character has been completed in the first video game, the rescuee status data included in the second save data is overwritten to “no need to be rescued (a state where the character does not need to be rescued)”. After step S9, the video game device 10 exits the first game process.

Then, the player chooses to play the second video game, in response to which the video game device 10 again starts executing the second video game program based on the current second save data (step S10). Since the second save data indicates “no need to be rescued”, the player can resume the second video game from the position where the second player character was defeated (step S11). As described above, where the second player character is defeated by an enemy character in the second video game, the second player character can be rescued in the first video game.

FIG. 5 shows the flow of the game process where the second player character rescues the first player character. In FIG. 5, as in FIG. 4, the first game process is shown along the vertical line on the left, and the second game process is shown along the vertical line on the right.

Referring to FIG. 5, first, the video game device 10 is executing the first video game program, and the player is playing the first video game. Then, the first player character is defeated by an enemy character (step S21). If the player chooses to have the second player character rescue the first player character in the second video game (i.e., to request a rescue by the second player character), the video game device 10 saves, in the memory card 17, the status of the game at the point in time when the first player character was defeated by the enemy character (step S22).

The first save data includes, as does the second save data, rescuee status data indicating whether or not the first player character needs to be rescued. In step S22, the rescuee status data is overwritten to “to be rescued”. Where the rescuee status data indicates “to be rescued”, the player cannot play the first video game before the rescue is completed in the second video game.

Then, the video game device 10 overwrites the second save data stored in the cartridge 18 according to the status of the first video game (step S23). In the present embodiment, the second save data includes rescue status data indicating whether or not it is possible for the second player character to rescue the first player character. Since the first player character is defeated in step S21, the rescue status data included in the second save data is overwritten to “rescuable” in step S23. Where the rescue status data indicates “rescuable”, the player can play the second video game with the object being to rescue the first player character. After step S23, the video game device 10 once exits the first game process.

After step S23, the player chooses to play the second video game, in response to which the video game device 10 starts executing the second video game program (step S24), thereafter starting the second video game (step S25). At the start of the video game, a marker (e.g., a flag) is displayed at a position in the dungeon where the first player character has been defeated. In order to rescue the first player character, the player controls the second player character so that the second player character reaches the position of the marker. The second player character arriving at the position of the marker means that the rescue of the first player character is completed (step S26).

After the rescue of the first player character is completed, the video game device 10 saves, in the cartridge 18, the status of the second video game at the point in time when the rescue is completed (step S27). Then, the rescue status data included in the second save data is overwritten to “unrescuable”. After step S27, the video game device 10 exits the second video game.

After step S27, the player chooses to play the first video game, in response to which the video game device 10 again starts executing the first video game program (step S28). Then, the video game device 10 reads out the second save data, and detects the status of the second video game (step S29). Specifically, the video game device 10 obtains the rescuee status data included in the second save data. At this point, the rescue status data indicates “unrescuable”.

Then, the video game device 10 overwrites the first save data stored in the memory card 17 according to the second save data obtained in step S29, i.e., according to the status of the second video game (step S30). Specifically, since the rescue status data included in the second save data indicates “unrescuable”, the rescuee status data included in the first save data is overwritten to “no need to be rescued”.

After step S30, the video game device 10 starts the first video game based on the current first save data. Then, since the rescuee status data included in the first save data stored in the memory card 17 indicates “no need to be rescued”, the player can resume the first video game from the position where the first player character was defeated (step S31). As described above, where the first player character is defeated by an enemy character in the first video game, the first player character can be rescued in the second video game.

Thus, in the present embodiment, the contents of the save data in a game, e.g., a second game, change according to the status of another game, e.g., a first game. Then, the second game is resumed based on the save data whose contents have been changed. Thus, one game is resumed, while reflecting the status of the other game. In the present embodiment, the statuses of two games influence each other, whereby the two games can be associated with each other. This gives a wider variety of game scenarios of the two games, thereby improving the game playability.

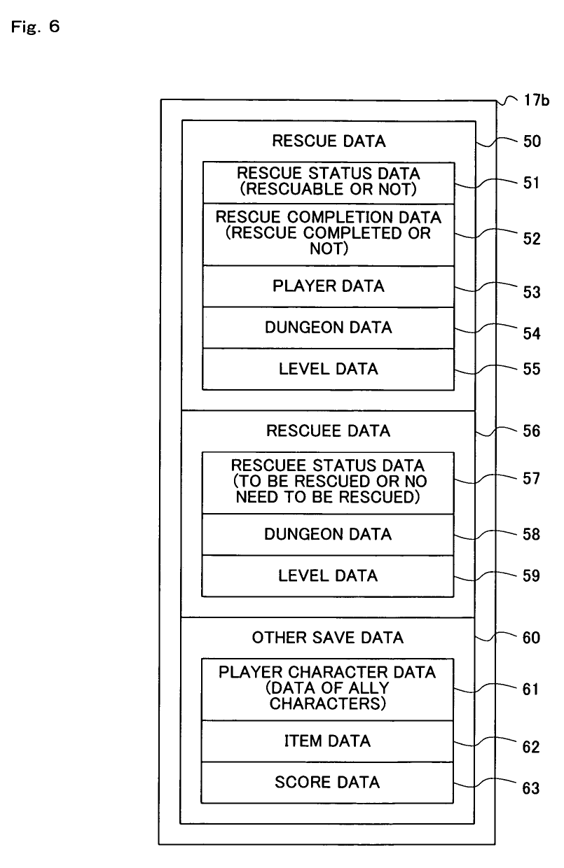

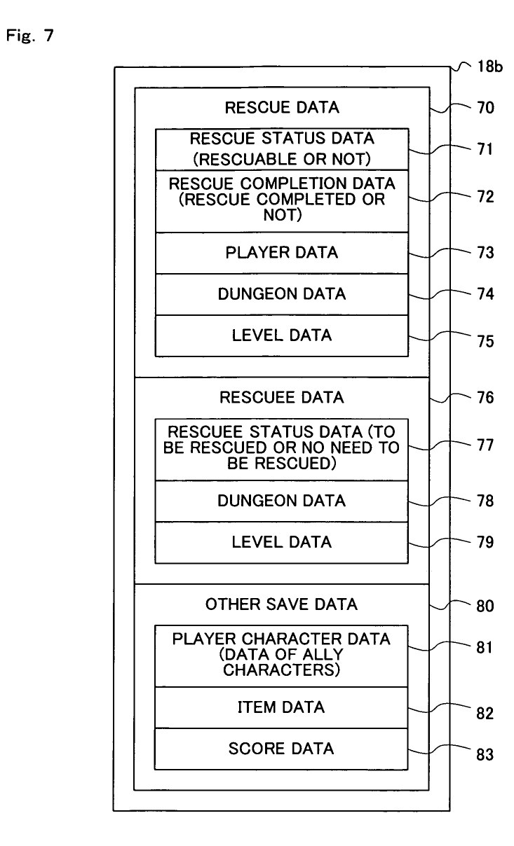

The details of the game process to be performed by the video game device 10 when executing the video game program of the present embodiment will now be described. First, the save data used in the game process will be described with reference to FIGS. 6 and 7. FIG. 6 shows the first save data stored in the memory card 17. Referring to FIG. 6, the flash memory 17b of the memory card 17 stores rescue data 50, rescuee data 56 and other save data 60.

The rescue data 50 is data regarding the rescue of the player character of the second game (the second player character). The rescue data 50 includes rescue status data 51 as described above, rescue completion data 52, player data 53, dungeon data 54, and level data 55. The rescue status data 51 represents whether or not it is possible for the first player character to rescue the second player character. Where it is possible to rescue the second player character, i.e., where the state of the second player character is “to be rescued”, the rescue status data 51 indicates “rescuable”. Where it is not possible to rescue the second player character, i.e., where the status of the second player character is “no need to be rescued”, the rescue status data 51 indicates “unrescuable”.

The rescue completion data 52 represents whether or not the rescue of the second player character by the first player character has been completed. Where the rescue has been completed, the rescue completion data 52 indicates “rescue completed”, and indicates “rescue not completed” otherwise.

The player data 53 is data regarding the player who is controlling the other player character (the second player character) now needing to be rescued. For example, the player data 53 represents the pre-registered player name. The dungeon data 54 represents the dungeon in which the second player character needs to be rescued, i.e., the dungeon in which the second player character has been defeated by an enemy character. The level data 55 represents the level in the dungeon on which the second player character has been defeated by the enemy character.

The rescuee data 56 is data regarding the rescue of the first player character. The rescuee data 56 includes rescuee status data 57 as described above, dungeon data 58, and level data 59. As described above, the rescuee status data 57 indicates whether or not the first player character needs to be rescued. Specifically, where the first player character has been defeated by an enemy, the rescuee status data 57 indicates “to be rescued”. Where the first player character has not been defeated by an enemy or the rescue of the first player character (by the second player character) has been completed, the rescuee status data 57 indicates “no need to be rescued”.

The dungeon data 58 represents the dungeon in which the first player character needs to be rescued, i.e., the dungeon in which the first player character has been defeated by an enemy character. The level data 59 represents the level in the dungeon on which the first player character has been defeated by the enemy character.

Moreover, the first save data includes player character data 61, item data 62, and score data 63. The player character data 61 represents the status of the first player character at the time of the save. Specifically, the player character data 61 includes data representing the position of the first player character in the game world and the hit point value thereof at the time of the save. In the present embodiment, the first player character can explore the dungeon with ally characters. The player character data 61 includes data of the ally characters that the first player character is with at the time of the save.

The item data 62 represents items owned by the first player character at the time of the save. The score data 63 represents the score of the first player character at the time of the save. In the present embodiment, when the first or second player character rescues the other player character, the rescuer player character is awarded some points. In the first video game or the second video game, each player character can receive various benefits according to the awarded points. For example, a player character may be awarded a particular item or a new ally character when the points accumulate over a predetermined number.

FIG. 7 shows the second save data stored in the cartridge 18. Referring to FIG. 7, the flash memory 18b of the cartridge 18 stores rescue data 70, rescuee data 76 and other save data 80.

The rescue data 70 is data regarding the rescue of the player character of the other game (the first player character). The rescue data 70 includes rescue status data 71 as described above, rescue completion data 72, player data 73, dungeon data 74, and level data 75. The rescue status data 71 represents whether or not it is possible for the second player character to rescue the first player character. Where it is possible to rescue the first player character, i.e., where the state of the first player character is “to be rescued”, the rescue status data 71 indicates “rescuable”. Where it is not possible to rescue the first player character, i.e., where the status of the first player character is “no need to be rescued”, the rescue status data 71 indicates “unrescuable”.

The rescue completion data 72 represents whether or not the rescue of the first player character by the second player character has been completed. Where the rescue has been completed, the rescue completion data 72 indicates “rescue completed”, and indicates “rescue not completed” otherwise.

The player data 73 is data regarding the player who is controlling the other player character (the first player character) now needing to be rescued. For example, the player data 73 represents the pre-registered player name. The dungeon data 74 represents the dungeon in which the first player character needs to be rescued, i.e., the dungeon in which the first player character has been defeated by an enemy character. The level data 75 represents the level in the dungeon on which the first player character has been defeated by the enemy character.

The rescuee data 76 is data regarding the rescue of the second player character. The rescuee data 76 includes rescuee status data 77 as described above, dungeon data 78, and level data 79. As described above, the rescuee status data 77 indicates whether or not the second player character needs to be rescued. Specifically, where the second player character has been defeated by an enemy, the rescuee status data 77 indicates “to be rescued”. Where the second player character has not been defeated by an enemy or the rescue of the second player character (by the first player character) has been completed, the rescuee status data 77 indicates “no need to be rescued”.

The dungeon data 78 represents the dungeon in which the second player character needs to be rescued, i.e., the dungeon in which the second player character has been defeated by an enemy character. The level data 79 represents the level in the dungeon on which the second player character has been defeated by the enemy character.

Moreover, the second save data includes player character data 81, item data 82, and score data 83. The player character data 81 represents the status of the second player character at the time of the save. Specifically, the player character data 81 includes data representing the position of the second player character in the game world and the hit point value thereof at the time of the save. In the present embodiment, the second player character can explore the dungeon with ally characters, as can the first player character. The player character data 81 includes data of the ally characters that the second player character is with at the time of the save. The item data 82 represents items owned by the second player character at the time of the save. The score data 83 represents the score of the second player character at the time of the save.

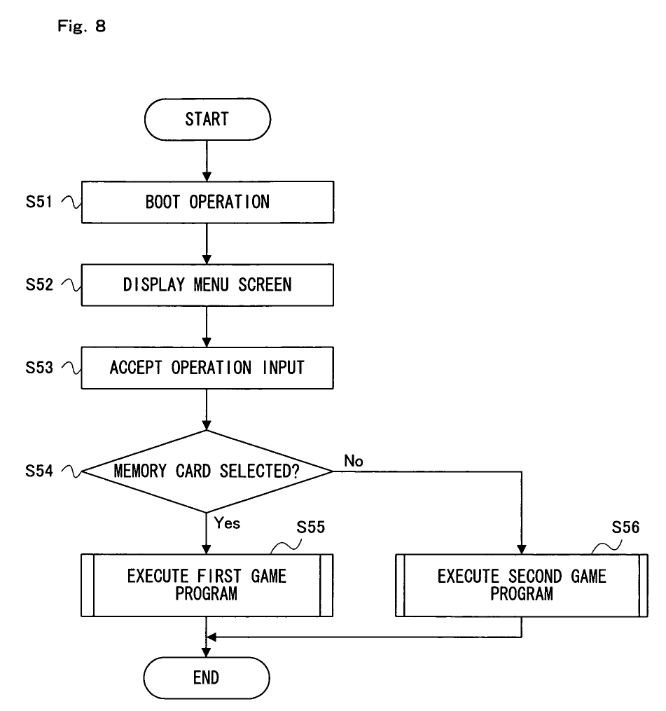

The details of the game process to be performed by the video game device 10 when executing the first or second video game program will now be described with reference to FIGS. 8 to 14. FIG. 8 is a main flow chart showing the flow of the game process performed by the video game device 10. As the power of the video game device 10 is turned ON, the first CPU core 21 the video game device 10 performs a boot operation in step S51. For example, the first CPU core 21 executes a boot program stored in a ROM provided in the video game device 10, thus initializing the work memory of the RAM 24, registers, etc. Step S51 and steps S52 to S54 to be described later are performed by executing a program or programs pre-stored in the video game device 10. In the following description, portions of the game process relevant to the rescue of a player character between the first video game and the second video game will be described in detail, while other portions that are not directly relevant to the present invention will not be described in detail.

In step S52, the first CPU core 21 displays a menu screen (not shown) on the second LCD 12 by using, for example, the first GPU 26, or the like. In the menu screen, a display area is defined for each storage medium (the memory card 17 and the cartridge 18). If a storage medium is inserted, the title image of the video game stored in the storage medium is displayed in the display area defined for that storage medium. If the storage medium is not inserted, a message such as “no cartridge inserted” is displayed in the display area defined for that storage medium. The image data used for displaying the menu screen is obtained from the built-in ROM, and data used for displaying the title image of the video game is obtained from the storage medium storing the video game program of that video game. After the menu screen is displayed, the user can instruct to execute a video game program stored in a storage medium by touching on a display area defined for that storage medium with the stylus 16, or the like. Alternatively, the user may instruct to execute a video game program stored in a storage medium by moving the cursor into the display area defined for that storage medium and then operating the A button 14d. When a storage medium that is not being inserted is selected, the user's operation is ignored.

Then, in step S53, the first CPU core 21 receives a control input from the user indicating which storage medium has been selected. Specifically, the first CPU core 21 obtains control input data from the touch panel 15 and the control switch section 14 via the I/F circuit 25. Then, in step S54, the first CPU core 21 determines whether or not the memory card 17 is selected in the menu screen displayed in step S52. The determination of step S54 is made based on the control input received in step S53. The operation of step S54 is to determine whether the user has selected the display area for the memory card 17 or that for the cartridge 18 in the menu screen. If it is determined in step S54 that the memory card 17 has been selected, the process proceeds to step S55. If it is determined in step S54 that the memory card 17 has not been selected (i.e., the cartridge 18 has been selected), the process proceeds to step S56.

In step S55, the first CPU core 21 executes the first video game program stored in the memory card 17 to perform the first game process. Thus, the player can play the first video game. In step S56, the first CPU core 21 executes the second video game program stored in the cartridge 18 to perform the second game process. Thus, the player can play the second video game. The details of steps S55 and S56 will be described later. After step S55 or S56, the first CPU core 21 exits the process shown in FIG. 8.

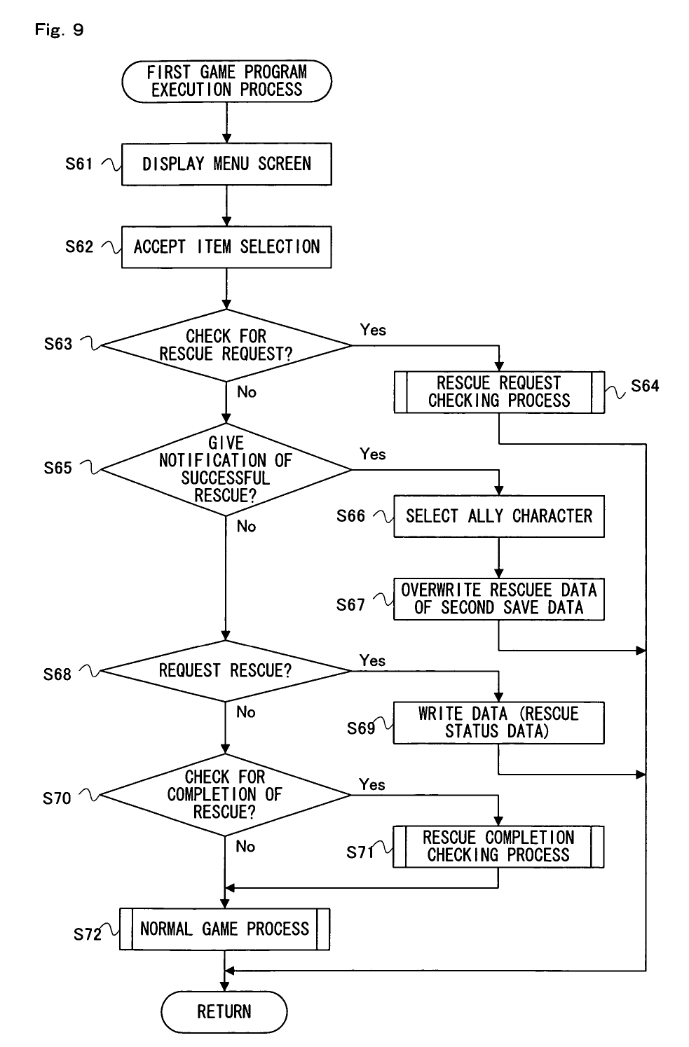

Referring now to FIGS. 9 to 12, the details of the first video game program executing process of step S55 will be described. FIG. 9 is a flow chart showing the detailed flow of step S55 shown in FIG. 8. In the present embodiment, the first video game program executing process is basically performed by the first CPU core 21, and the process of writing/reading the second save data to/from the cartridge 18 is performed by the second CPU core 22.

First, in step S61 of the first video game program executing process, the menu screen is displayed on the second LCD 12. The menu screen displays up to five items, from among which the player selects an item. The game process to follow varies depending on the item selected by the player.

Specifically, the menu screen displays the following five items: (1) “Check for ‘Help me’ email”, (2) “Send ‘Character revived’ email”, (3) “Send ‘Help me’ email”, (4) “Check for ‘Character revived’ email”, and (5) “Normal game”.

The item (1) “Check for ‘Help me’ email” is an item that should be selected when the player intends to check whether or not a rescue is being requested in the second video game. The item (1) is displayed in the menu screen when the cartridge 18 is inserted in the video game device 10.

The item (2) “Send ‘Character revived’ email” is an item that should be selected when the player intends to notify the second video game of a successful rescue of the second player character in the first video game. The item (2) is displayed or not displayed in the menu screen depending on the first save data. Specifically, the item (2) is displayed in the menu screen only when the rescue completion data 52 included in the rescue data 50 of the first save data indicates “rescue completed”.

The item (3) “Send ‘Help me’ email” is an item that should be selected when the first player character is defeated by an enemy character in the first video game and the player intends to request a rescue by the second player character. The item (3) is displayed or not displayed in the menu screen depending on the first save data. Specifically, the item (3) is displayed in the menu screen only when the rescuee status data 57 included in the rescuee data 56 of the first save data indicates “to be rescued”.

The item (4) “Check for ‘Character revived’ email” is an item that should be selected when the player intends to check whether or not the rescue of the first player character in the second video game has been completed after the first player character is defeated by an enemy character in the first video game. The item (4) is displayed or not displayed in the menu screen depending on the first save data. Specifically, the item (4) is displayed in the menu screen only when the rescuee status data 57 included in the rescuee data 56 of the first save data indicates “to be rescued”.

The item (5) is an item that should be selected when the player intends to start a normal game of the first video game. The item (5) is always included in the menu screen displayed in step S61.

Then, in step S62, the first CPU core 21 accepts an input from the user selecting one of the items displayed in the menu screen. In step S62, the player selects one item according to the status of the game.

In step S63, it is determined whether or not the player has selected to check for a rescue request (the item (1)). If so, the process proceeds to step S64. Otherwise (if a different item has been selected), the process proceeds to step S65.

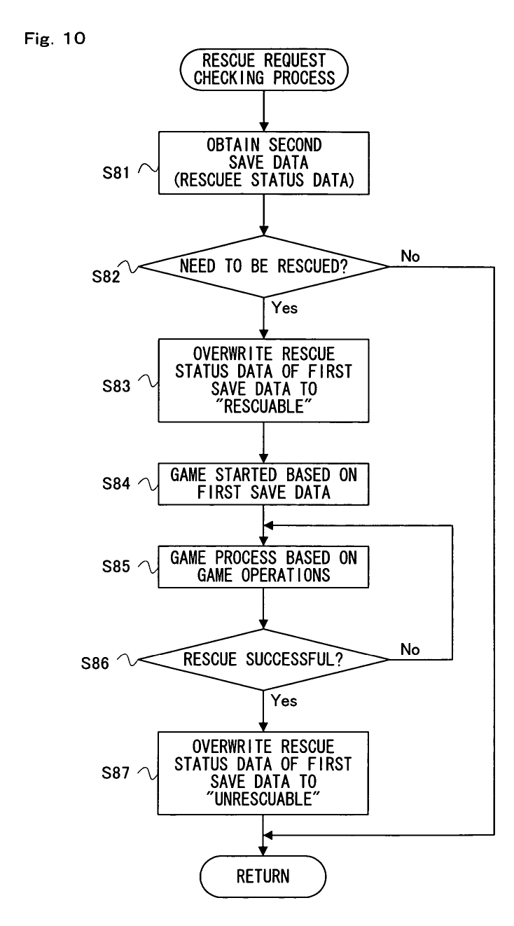

In step S64, the rescue request checking process is performed. The rescue request checking process is a process of checking if a rescue is being requested in the second video game. The process of step S64 will now be described in detail with reference to FIG. 10.

FIG. 10 is a flow chart showing details of the process of step S64 shown in FIG. 9. Referring to FIG. 10, first, in step S81 of the rescue request checking process, the process obtains the second save data stored in the cartridge 18. Specifically, the first CPU core 21 instructs the second CPU core 22 to read out the second save data. The second CPU core 22 accesses the cartridge 18 to read out the rescuee data 76 of the second save data, and sends it to the first CPU core 21. Thus, the first CPU core 21 can know the current game status of the second video game (i.e., whether or not the second player character is waiting for a rescue).

In step S82, it is determined whether or not the second player character is needing to be rescued. The determination is made based on the rescuee status data 77 included in the rescuee data 76 obtained in step S81. Specifically, if the rescuee status data 77 indicates “to be rescued”, it is determined that the second player character is needing to be rescued. If the rescuee status data 77 indicates “no need to be rescued”, it is determined that the second player character is not needing to be rescued. If it is determined in step S82 that the second player character is needing to be rescued, the process proceeds to step S83. Otherwise, the first CPU core 21 skips steps S83 to S87 to exit the rescue request checking process.

In step S83, the first save data stored in the memory card 17 is overwritten. Specifically, the first CPU core 21 overwrites the rescue status data 51 included in the rescue data 50 of the first save data to “rescuable”.

Then, in step S84, the first CPU core 21 starts the first video game based on the first save data. Thus, a game for rescuing the second player character is started in the first video game. Specifically, when the dungeon of the game world in the first video game is constructed, a marker is defined at a predetermined position on a level of the dungeon where the second player character was defeated. The dungeon and the level where the second player character was defeated can be identified based on the dungeon data 78 and the level data 79 included in the rescuee data 76 obtained in step S81. In the present embodiment, the map of the dungeon is changed each time the player character enters the dungeon. Therefore, while the marker is defined in the dungeon in which the second player character was defeated and on the level in the dungeon where the second player character was defeated, the position of the marker on that level is randomly determined.

In step S85, after step S84, various game processes are performed based on game operations by the player. For example, the game processes include a process of moving the first player character around in the dungeon in response to a game operation for moving the first player character, a process of arranging an encounter between the first player character and an enemy character based on a predetermined condition, a process of changing the hit point value of the enemy character in response to an attack by the first player character, and a process of changing the hit point value of the first player character in response to an attack by the enemy character.

In step S86, it is determined whether or not the first player character has successfully rescued the second player character. Specifically, the first CPU core 21 determines whether or not the first player character has reached the position of the marker. If it is determined that the rescue has been successfully completed, the process proceeds to step S87. Otherwise, the process goes back to step S85.

Steps S85 and S86 are repeated for each one-frame period, for example. Steps S85 and S86 are repeated until the first player character successfully rescues the second player character. The game thus proceeds. During the game, the player performs a game operation so that the first player character reaches the position of the marker.

In step S87, the first save data stored in the memory card 17 is overwritten. Specifically, the first CPU core 21 overwrites the rescue status data 51 included in the rescue data 50 of the first save data to “unrescuable”, and overwrites the rescue completion data 52 included in the rescue data 50 to “rescue completed”. In step S87, the score data 63 included in the first save data is also overwritten so as to add a predetermined number of points to the score. After step S87, the first CPU core 21 exits the rescue request checking process.

Although not shown in the figure, if the first player character attempting to rescue the second player character is defeated by an enemy character during the loop of steps S85 and S86, the first CPU core 21 ends the game. Then, the process of step S87 is not performed.

After the rescue request checking process, the first CPU core 21 exits the first video game program executing process shown in FIG. 9. Thus, the game process shown in FIG. 8 ends. If the player restarts the video game device 10, performs a predetermined operation (the item (3)), and then plays the second video game, the player can resume the second video game from the position where the player character was defeated by the enemy character.

Referring back to FIG. 9, in step S65, it is determined whether or not the player has selected to give a notification of a successful rescue (the item (2)). If so, the process proceeds to steps S66 and S67. Otherwise (if a different item has been selected), the process proceeds to step S68.

In steps S66 and S67, the first CPU core 21 performs the process of notifying the second video game of the successful rescue of the second player character by the first player character, i.e., the process of overwriting the second save data to indicate the successful rescue.

In step S66, the user selects an ally character that the first player character is with. In the present embodiment, after the first player character rescues the second player character, the user can transfer an ally character of the first player character to the party of the second player character as an assistant in order to reinforce the party of the second player character who was defeated by an enemy character. Step S66 is a process of selecting an ally character to be transferred as an assistant. The user can select no ally character.

In step S67, the second save data is overwritten. Specifically, the first CPU core 21 instructs the second CPU core 22 to overwrite the second save data. The second CPU core 22 accesses the cartridge 18 to overwrite the rescuee status data included in the rescuee data 76 of the second save data to “no need to be rescued”. If there is an ally character selected in step S63, the player character data 81 of the second save data is overwritten so as to add the selected character. In step S67, the first CPU core 21 overwrites the rescue completion data 52 the rescue data 50 of the first save data to “rescue not completed”.

After step S67, the first CPU core 21 exits the first video game program executing process shown in FIG. 9. Thus, the game process shown in FIG. 8 ends. Through the process of step S67, the successful rescue of the second player character by the first player character is notified to the second video game. Therefore, if the player restarts the video game device 10 and plays the second video game, the player can resume the game from the position where the second player character was previously defeated.

In step S68, it is determined whether or not the player has selected to request a rescue (the item (3)). The item (3) is an item selected when the player intends to request a rescue after the first player character is defeated by an enemy character in the normal game process (step S72) to be described later. Therefore, in the rescuee data 56 of the first save data, the rescuee status data 57 indicates “to be rescued”. At this point, the dungeon data 58 indicates the dungeon in which the first player character was defeated by an enemy character, and the level data 59 indicates the level on which the first player character was defeated by the enemy character. If it is determined in step S68 that the player has selected the item (3), the process proceeds to step S69. Otherwise (is a different item has been selected), the process proceeds to step S70.

In step S69, the second save data stored in the cartridge 18 is overwritten. Specifically, the first CPU core 21 uses the second CPU core 22 to overwrite the rescue status data 71 included in the rescue data 70 of the second save data to “rescuable”. Moreover, data representing the player name of the player of the first video game is written to the cartridge 18 as the player data 73. Moreover, the dungeon data 58 included in the rescuee data 56 of the first save data is written to the cartridge 18 as the dungeon data 78 included in the rescue data 70 of the second save data, and the level data 59 included in the rescuee data 56 of the first save data is written to the cartridge 18 as the level data 79 included in the rescue data 70 of the second save data.

After step S69, the first CPU core 21 exits the first video game program executing process shown in FIG. 9. Thus, the game process shown in FIG. 8 ends. Through the process of step S69, the second video game is notified that the first player character is waiting for a rescue. Therefore, when the player restarts the video game device 10 and plays the second video game, the player can play a game for rescuing the first player character in the second video game.

In step S70, it is determined whether or not the player has selected to check for the completion of the rescue (the item (4)). The item (4) is an item selected when the player intends to check if the rescue of the first player character by the second player character has been completed in the second video game after the first player character is defeated by an enemy character in the normal game process (step S72). If it is determined in step S70 that the player has selected the item (4), the process proceeds to step S71. Otherwise (if the item (5) has been selected), the process proceeds to step S72.

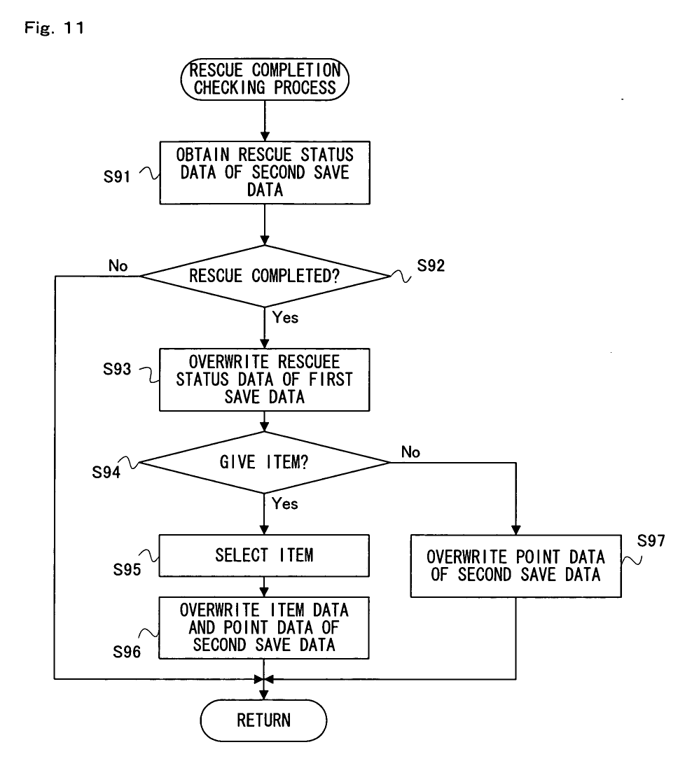

In step S71, the rescue completion checking process is performed. The rescue completion checking process is a process of checking if the rescue of the first player character by the second player character has been completed in the second video game. The process of step S71 will now be described in detail with reference to FIG. 11.

FIG. 11 is a flow chart showing details of the process of step S71 shown in FIG. 9. Referring to FIG. 11, first, in step S91 of the rescue completion checking process, the process obtains the second save data stored in the cartridge 18. Specifically, the first CPU core 21 instructs the second CPU core 22 to read out the second save data. The second CPU core 22 accesses the cartridge 18 to read out the rescue data 70 of the second save data, and sends it to the first CPU core 21. Thus, the first CPU core 21 can know the current game status of the second video game (i.e., whether or not the second player character has completed the rescue).

In step S92, it is determined whether or not the second player character has completed the rescue. The determination is made based on the rescue completion data 72 included in the rescue data 70 obtained in step S91. Thus, if the rescue completion data 72 indicates “rescue completed”, it is determined that the second player character has completed the rescue. If the rescue completion data 72 indicates “rescue not completed”, it is determined that the second player character has not completed the rescue. If it is determined in step S92 that the second player character has completed the rescue, the process proceeds to step S93. If it is determined that the second player character has not completed the rescue, the first CPU core 21 skips steps S93 to S97 to exit the rescue completion checking process.

In step S93, the first save data stored in the memory card 17 is overwritten. Specifically, the first CPU core 21 overwrites the rescuee status data 57 included in the rescuee data 56 in the first save data to “no need to be rescued”. Thus, the game status “the first player character has been rescued” in the second video game is reflected in the first save data of the first video game.

In the present embodiment, the rescued player character can give an item to the rescuer player character, as a token of gratitude. Moreover, the rescuer player character is awarded some points as described above. The process of steps S94 to S97 to be described next is a process of awarding the rescuer player character with an item being a token of gratitude and with points.

In step S94, it is determined whether or not to give an item to the second player character. The determination is made according to the user's instruction. In step S94, a message such as “Give an item?” is displayed on the second LCD 12, and the player chooses whether or not to give an item. If it is determined in step S94 that an item is to be given, the process proceeds to steps S95 and S96. Otherwise, the process proceeds to step S97.

In step S95, the player selects an item to be given to the second player character. For example, the player selects an item to be given to the second player character from among a set of items currently being possessed by the first player character. Then, in step S96, the item data 82 and the score data 83 included in the second save data are overwritten. Specifically, the item data 82 is overwritten so as to add the item selected in step S95. The score data 83 is overwritten so as to add a predetermined number of points to the score.

In step S97, the score data 83 included in the second save data is overwritten. Specifically, the score data 83 is overwritten so as to add a predetermined number of points to the score.

After step S96 or S97, the first CPU core 21 exits the rescue completion checking process. After the rescue completion checking process, the first CPU core 21 performs the process of step S72 shown in FIG. 9. Through the rescue completion checking process, the first video game is notified that the rescue has been completed in the second video game (if the rescue has been completed in the second video game). Therefore, when the player subsequently plays the first video game in the normal game process (step S72), the player can resume the first video game from the position where the player character was defeated by an enemy character.

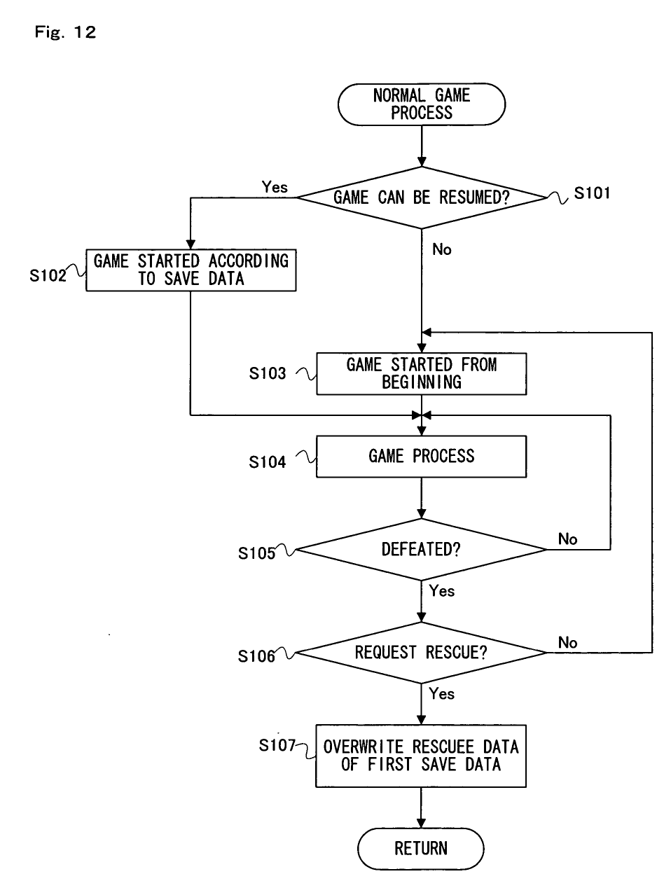

The process of step S72 shown in FIG. 9 will now be described. In step S72, the normal game process is performed. The normal game process as used herein refers to a game process that is different from that of a game for rescuing a player character who has been defeated in the other game (steps S85 and S86). If the player character is defeated by an enemy character during the normal game process, the player can request a rescue of the defeated player character by the other player character. The process of step S72 will now be described in detail with reference to FIG. 12.

FIG. 12 is a flow chart showing details of the process of step S72 shown in FIG. 9. Referring to FIG. 12, first, in step S101 of the normal game process, it is determined whether or not the game can be resumed based on the first save data. In the present embodiment, if the status of the first player character is “to be rescued”, the game cannot be resumed based on the first save data, i.e., the game cannot be resumed from the position where the player character was defeated by an enemy character. Therefore, the first CPU core 21 reads out the rescuee status data 57 of the rescuee data 56 included in the first save data stored in the memory card 17 to determine whether or not the rescuee status data 57 indicates “to be rescued”. If so, it is determined that the game cannot be resumed based on the first save data. If the rescuee status data 57 indicates “no need to be rescued”, it is determined that the game can be resumed based on the first save data. If it is determined that the game can be resumed based on the first save data, the process proceeds to step S102. Otherwise, the process proceeds to step S103.

In step S102, the game is started according to the first save data (the other save data 60). Specifically, the first video game is started while placing the first player character at the position indicated by the player character data 61 of the first save data. The hit point value of the first player character is set to a value specified by the player character data 61.

In step S103, the first video game is started from the beginning. Specifically, the first video game is started while placing the first player character at a predetermined start position. The hit point value of the first player character is set to a predetermined initial value.

After step S102 or S103, the process proceeds to step S104. No marker is defined in the dungeon in steps S102 and S103, as opposed to step S84.

In step S104, various game processes are performed based on game operations by the player. Step S104 is similar to step S85. Then, in step S105, it is determined whether or not the first player character has been defeated by an enemy character, i.e., whether or not the hit point value of the first player character has become 0. If it is determined that the first player character has been defeated, the process proceeds to step S106. Otherwise, the process proceeds to step S104.

Steps S104 and S105 are repeated for each one-frame period, for example. Steps S104 and S105 are repeated until the first player character is defeated by an enemy character. The game thus proceeds. Although not shown in the figure, if the player character realizes a game object (e.g., defeating a boss character, or finding treasure) during the loop of steps S104 and S105, the game is considered to have been completed, and the first CPU core 21 exits the process.

In step S106, the first CPU core 21 determines whether or not to request a rescue of the first player character by the other player character (the second player character). The determination is made according to the user's instruction. Specifically, when the first player character is defeated by an enemy character, a message such as “Request a rescue?” is displayed on the second LCD 12 in step S106. Then, the user chooses whether or not to request a rescue. If it is determined in step S106 that a rescue is to be requested, the process proceeds to step S107. Otherwise, the process goes back to step S103. Then, the other data 60 is erased (reset), and the first player character starts over to explore the dungeon from the start position.

In step S107, the first save data stored in the memory card 17 is overwritten. Specifically, the first CPU core 21 overwrites the rescuee status data 57 included in the rescuee data 56 in the first save data to “to be rescued”. Thus, when the first video game program is executed next, the player can select the item (3), thereby notifying the second video game that the first player character is waiting for a rescue. In step S107, the dungeon data 58 included in the rescuee data 56 is overwritten to indicate the dungeon in which the first player character was defeated by an enemy character. The level data 59 included in the rescuee data 56 is overwritten to indicate the level on which the first player character was defeated by the enemy character. The data specifying the position of the first player character included in the player character data 61 is overwritten to indicate the position at which the first player character was defeated by the enemy character.

After step S107, the first CPU core 21 exits the normal game process. Thus, the first video game program executing process ends, and the game process shown in FIG. 8 ends.

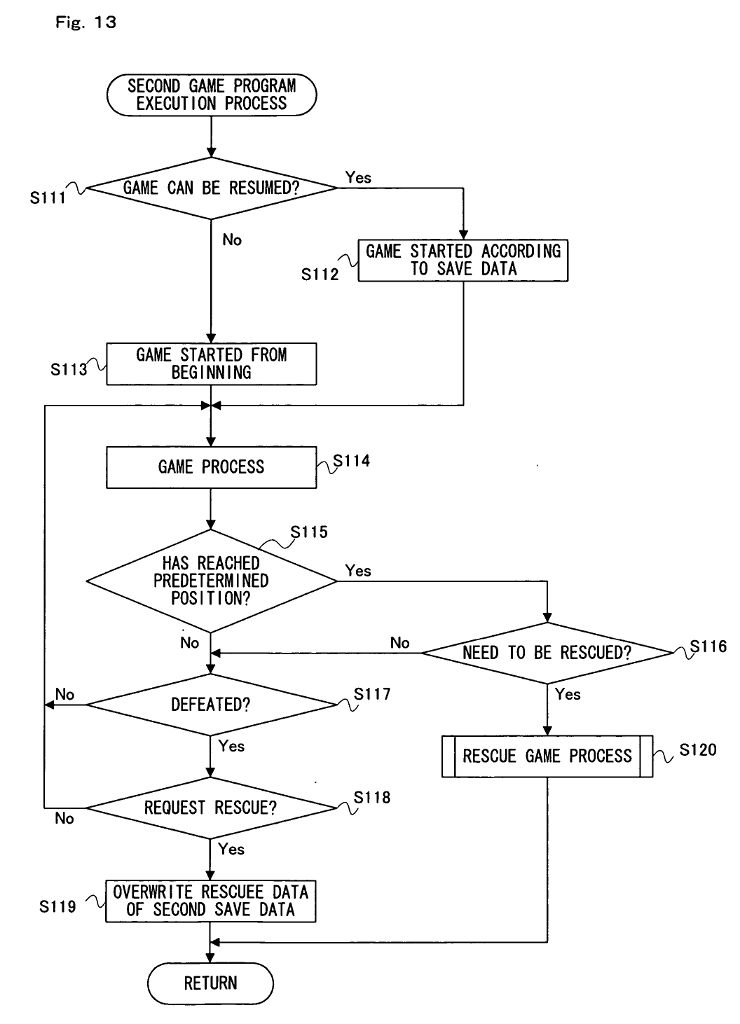

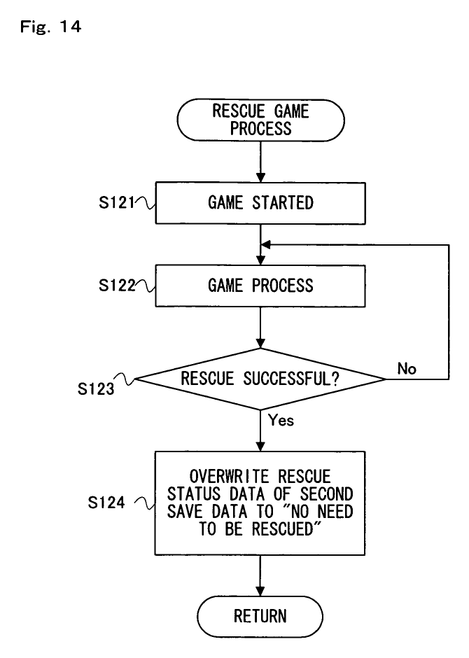

Referring now to FIGS. 13 and 14, the details of the second video game program executing process of step S56 will be described. FIG. 13 is a flow chart showing the detailed flow of step S56 shown in FIG. 8. In the present embodiment, the second video game program executing process is performed by the second CPU core 22.

First, in step S111 of the second video game program executing process, it is determined whether or not the game can be resumed based on the second save data. In the present embodiment, if the status of the second player character is “to be rescued”, the game cannot be resumed based on the second save data, i.e., the game cannot be resumed from the position where the player character was defeated by an enemy character. Therefore, the second CPU core 22 reads out the rescuee status data 77 of the rescuee data 76 included in the second save data stored in the cartridge 18 to determine whether or not the rescuee status data 77 indicates “to be rescued”. If so, it is determined that the game cannot be resumed based on the second save data. If the rescuee status data 77 indicates “no need to be rescued”, it is determined that the game can be resumed based on the second save data. If it is determined that the game can be resumed based on the second save data, the process proceeds to step S112. Otherwise, the process proceeds to step S113.

In step S112, the game is started according to the second save data (the other save data 80). Specifically, the second video game is started while placing the second player character at the position indicated by the player character data 81 of the second save data. The hit point value of the second player character is set to a value specified by the player character data 81.

In step S113, the second video game is started from the beginning. Specifically, the second video game is started while placing the second player character at a predetermined start position. The hit point value of the second player character is set to a predetermined initial value.

After step S112 or S113, the process proceeds to step S114. No marker is defined in the dungeon in steps S112 and S113, as opposed to step S122 to be described later.

In step S114, various game processes are performed based on game operations by the player. For example, the game processes include a process of moving the second player character around in the dungeon in response to a game operation for moving the second player character, a process of arranging an encounter between the second player character and an enemy character based on a predetermined condition, a process of changing the hit point value of the enemy character in response to an attack by the second player character, and a process of changing the hit point value of the second player character in response to an attack by the enemy character.

In the second video game, if the second player character reaches a predetermined rescue station in the game world (e.g., the building of “Rescue Station”), the player can choose whether or not to set out for a rescue of the other (first) player character. In the second game process, it is determined in step S115, following step S114, whether or not the second player character has reached the rescue station. If it is determined that the second player character has reached the rescue station, the process proceeds to step S116. Otherwise, the process proceeds to step S117.

In step S116, it is determined whether or not the first player character is needing to be rescued. The determination is made based on the rescue status data 71 included in the rescue data 70 of the second save data. Specifically, if the rescue status data 71 indicates “rescuable”, it is determined that the first player character is needing to be rescued. If the rescue status data 71 indicates “unrescuable”, it is determined that the first player character is not needing to be rescued. If it is determined in step S116 that the first player character is needing to be rescued, the process proceeds to step S120. Otherwise, the process proceeds to step S117.

In step S117, it is determined whether or not the second player character has been defeated by an enemy character, i.e., whether or not the hit point value of the second player character has become 0. If it is determined that the second player character has been defeated, the process proceeds to step S118. Otherwise, the process proceeds to step S114.

Steps S114 to S117 are repeated for each one-frame period, for example. Steps S114 to S117 are repeated until the second player character is defeated by an enemy character or until the second player character starts the rescue of the first player character. The game thus proceeds. Although not shown in the figure, if the player character realizes a game object (e.g., defeating a boss character, or finding treasure) during the loop of steps S114 to S117, the game is considered to have been completed, and the second CPU core 22 exits the process.

In step S118, the second CPU core 22 determines whether or not to request a rescue of the second player character by the other player character (the first player character). The determination is made according to the user's instruction. Specifically, when the second player character is defeated by an enemy character, a message such as “Request a rescue?” is displayed on the second LCD 12 in step S118. Then, the user chooses whether or not to request a rescue. If it is determined in step S118 that a rescue is to be requested, the process proceeds to step S119. Otherwise, the process goes back to step S114. Then, the other data 60 is erased (reset), and the second player character starts over to explore the dungeon from the start position.

In step S119, the second save data stored in the cartridge 18 is overwritten. Specifically, the second CPU core 22 overwrites the rescuee status data 77 included in the rescuee data 76 in the second save data to “to be rescued”. Thus, when the first video game program is executed next, it is possible to rescue the second player character by the first player character. In step S119, the dungeon data 78 included in the rescuee data 76 is overwritten to indicate the dungeon in which the second player character was defeated by an enemy character. The level data 79 included in the rescuee data 76 is overwritten to indicate the level on which the second player character was defeated by the enemy character. The data specifying the position of the second player character included in the player character data 81 is overwritten to indicate the position at which the second player character was defeated by the enemy character.

After step S119, the second CPU core 22 exits the second video game program executing process, and thus the game process shown in FIG. 8 ends.

In step S120, the rescue game process is performed. The rescue game process is a game process for a game whose object is to rescue the first player character by the second player character. Referring now to FIG. 14, the details of the rescue game process will be described.

FIG. 14 is a flow chart showing the detailed flow of step S120 shown in FIG. 13. First, in step S121 of the rescue game process, a game is started whose object is to rescue the first player character by the second player character. Specifically, when the dungeon of the game world in the first video game is constructed, a marker is defined at a predetermined position on a level of the dungeon where the second player character was defeated. The dungeon and the level where the first player character was defeated can be identified based on the dungeon data 74 and the level data 75 included in the rescue data 70 written in step S69. In the present embodiment, the map of the dungeon is changed each time the player character enters the dungeon in the second video game, as in the first video game. Therefore, while the marker is defined in the dungeon in which the first player character was defeated and on the level in the dungeon where the first player character was defeated, the position of the marker on that level is randomly determined.

In step S122, various game processes are performed based on game operations by the player. Step S122 is similar to step S114. Then, it is determined in step S123 whether or not the second player character has succeeded in the rescue of the first player character. Specifically, the second CPU core 22 determines whether or not the second player character has reached the position of the marker. If it is determined that the rescue has been successfully completed, the process proceeds to step S124. Otherwise, the process goes back to step S122.

Steps S122 and S123 are repeated for each one-frame period, for example. Steps S122 and S123 are repeated until the second player character successfully rescues the first player character. The game thus proceeds. During the game, the player performs a game operation so that the second player character reaches the position of the marker.

In step S124, the second save data stored in the cartridge 18 is overwritten. Specifically, the second CPU core 22 overwrites the rescue status data 71 included in the rescue data 70 of the second save data to “unrescuable”, and overwrites the rescue completion data 72 included in the rescue data 70 to “rescue completed”. In step S124, the score data 83 included in the second save data is also overwritten so as to add a predetermined number of points to the score. After step S124, the second CPU core 22 exits the rescue game process. Thus, the second video game program executing process ends, and the game process shown in FIG. 8 ends. The game process shown in FIGS. 8 to 14 is as described above.

With the game process described above, when the first game character is defeated by an enemy character during the first video game (Yes in step S105), for example, if the player requests a rescue (Yes in step S106, and Yes in step S68), the game status that the first game character is now waiting to be rescued is written to the second save data (step S69). In other words, the second save data is updated according to the game status “the first game character has been defeated”. Thus, a new game scenario is added to the second video game, whereby the player can play a rescue game whose object is to rescue the first player character. As described above, in the present embodiment, the status of the first video game is reflected in the status of the second video game.

Then, when the first player character is rescued in the second video game (Yes in step S123), the completion of the rescue is first written to the second save data (step S124). Thereafter, when the player plays the first video game, the first save data is updated according to the second save data (step S93). The first save data is updated according to the status of the second video game (“the first player character has been rescued in the second video game”). Thus, the first video game can be resumed based on the updated first save data (S102). Specifically, since the rescuee status data 57 of the first save data is updated to “no need to be rescued” according to the second save data, the game can be resumed from the position where the first player character was defeated. As described above, in the present embodiment, the status of the second video game is reflected in the status of the first video game.

When the second game character is defeated by an enemy character during the second video game (Yes in step S117), for example, if the player requests a rescue (Yes in step S118), the game status that the second game character is now waiting to be rescued is written to the second save data (step S119). Then, the first save data is updated according to the second save data (step S83). In other words, the first save data is updated according to the game status “the second game character has been defeated”. Thus, a new game scenario is added to the first video game, whereby the status of the second video game is reflected in the status of the first video game.

Then, when the second player character is rescued in the first video game (Yes in step S86), the completion of the rescue is written to the second save data (step S67). The second save data is updated according to the status of the first video game (“the second player character has been rescued in the first video game”). Thus, the second video game can be resumed based on the updated second saved at a (S112). Specifically, since the rescuee status data 77 of the second save data is updated to “no need to be rescued”, the game can be resumed from the position where the second player character was defeated. As described above, in the present embodiment, the status of the first video game is reflected in the status of the second video game.

As described above, according to the present embodiment, there is provided a video game in which two games are associated with each other, wherein the status of the first video game is reflected in the status of the second video game, and the status of the second video game is reflected in the status of the first video game. This gives a wider variety of game scenarios than that given when each game is played as a single game, thereby improving the playability of the games.

In the present embodiment, the status of each one of two games can be reflected in the status of the other. As a result, game settings as follows are possible. If a player character is defeated in one game so that the game could normally be no longer continued, the player can still recover from the uncontinuable state back to the continuable state by satisfying a predetermined condition (e.g., by rescuing the defeated player character) in the other game.

In the above embodiment, items and ally characters are transferred from the first video game to the second video game. In other embodiments, items and ally characters may be transferred from the second video game to the first video game, or in both directions between the first video game and the second video game. The method for transferring items from the second video game to the first video game may be as follows. Data representing items to be moved from the second video game to the first video game (to be given to the first player character) may be further stored in the cartridge 18 as the second save data. Then, the video game device 10 may read the second save data while executing the first video game program so as to check if there is any item to be transferred from the second video game to the first video game. If there is an item to be transferred, the video game device 10 updates the item data of the first save data so as to add the item. Thus, the item of the second player character can be given to the first player character. Ally characters can be transferred similarly.

While the two games are assumed to be of the same genre in the above embodiment, the two games do not always have to be of the same genre. For example, one may be a roll playing game while the other is an action game. The two games may be of the same genre but with different game levels and different characters.

While the video game device 10 of the above embodiment includes two CPUs, there may be only one CPU as long as it is capable of accessing both of the two storage media.

In the above embodiment, at least one of the two storage media (the memory card 17 and the cartridge 18) may be of a type that can be inserted in another video game device capable of receiving only that type of a storage medium. In other words, the video game device 10 of the present embodiment may be able to receive a storage medium that can be inserted in a different type of a video game device capable of receiving only one type of a storage medium. Thus, two games compatible with different types of video game devices can be associated with each other. For example, the video game device 10 may be an upward compatible model of the other video game device being an older model of the video game device 10.

The above embodiment is directed to a technique for changing the save data of one game according to the status of the other game. In the above embodiment, the hit point value of a player character is used as a specific example of a parameter representing the game status. The parameter representing the game status is not limited to a parameter regarding the status of the player character, but may be any other parameter that affects how the game progresses. The parameter may be, for example, a parameter representing the number of enemy characters appearing in the game. In a case where the configuration of the game world varies over time (e.g., where the configuration of the dungeon varies as in the embodiment above), the parameter may be a parameter representing such configuration.

In the above embodiment, the rescue status data and the rescuee status data are used as specific examples of save data that change according to the status of one game. In other embodiments, the save data may be any other data that is loaded at the start of a game and that affects how the game progresses. For example, the save data may be data regarding a player character or an enemy character (e.g., data representing the hit point value or the strength), or may be data representing the configuration of the game map.

The present invention can be used in a video game system, a video game device, or the like, aiming at, for example, associating two video games with each other by using a video game device that can receive two storage media at the same time.

While the invention has been described in detail, the foregoing description is in all aspects illustrative and not restrictive. It is understood that numerous other modifications and variations can be devised without departing from the scope of the invention.

What is claimed is:

1. A video game system, comprising a first storage medium, a second storage medium, and a video game device capable of receiving both the first storage medium and the second storage medium at the same time, wherein:
the first storage medium includes:
first program storage means for pre-storing a first video game program used for performing a first game process; and
first save data storage means for storing first save data regarding a first video game played by performing the first game process;
the second storage medium includes:
second program storage means for pre-storing a second video game program used for performing a second game process; and
second save data storage means for storing second save data regarding a second video game played by performing the second game process; and
the video game device includes:
first game process means for performing the first game process using the first save data;
second game process means for performing the second game process using the second save data;
first overwriting means for overwriting the first save data based on a status of the second video game; and
second overwriting means for overwriting the second save data based on a status of the first video game.

2. The video game system according to claim 1, wherein:
the video game device further includes third overwriting means for overwriting the first save data when the status of the first video game becomes equal to a predetermined first state to thereby indicate that the game status is equal to the first state;
the second game process means performs a predetermined game process for playing a game whose object is to satisfy a predetermined first condition regarding the status of the second video game when the status of the first video game becomes equal to the first state; and
the first overwriting means overwrites the first save data to indicate that the game status has been restored from the first state when the first condition is satisfied.

3. The video game system according to claim 1, wherein:
the video game device further includes fourth overwriting means for overwriting the second save data when the status of the second video game becomes equal to a predetermined second state to thereby indicate that the game status is equal to the second state;
the first game process means performs a predetermined game process for playing a game whose object is to satisfy a predetermined second condition regarding the status of the first video game when the status of the second video game becomes equal to the second state; and
the second overwriting means overwrites the second save data to indicate that the game status has been restored from the second state when the second condition is satisfied.

4. The video game system according to claim 1, wherein:
the video game device further includes fifth overwriting means for writing data representing the status of the second video game at a predetermined point in time to second save data storage means as the second save data while the second game process is being performed; and
the first overwriting means overwrites the first save data based on the second save data while the first game process is being performed.

5. The video game system according to claim 1, wherein the video game device further includes overwrite selection means for selecting, according to a user's operation, whether or not to perform the overwriting operation by the first overwriting means or the second overwriting means.

6. The video game system according to claim 1, wherein:
the video game device further includes game selection means for selecting, according to a player's operation, whether to play the first video game or the second video game;
the first game process means performs the first game process by executing the first video game program when the first video game is selected by the game selection means; and
the second game process means performs the second game process by executing the second video game program when the second video game is selected by the game selection means.

7. The video game system according to claim 1, wherein one of the first storage medium and the second storage medium can be inserted in another video game device, which cannot receive the other one of the first storage medium and the second storage medium.

8. A video game device capable of receiving both a first storage medium and a second storage medium at the same time, wherein:
the first storage medium includes:
first program storage means for pre-storing a first video game program used for performing a first game process; and
first save data storage means for storing first save data regarding a first video game played by performing the first game process;
the second storage medium includes:
second program storage means for pre-storing a second video game program used for performing a second game process; and
second save data storage means for storing second save data regarding a second video game played by performing the second game process; and
the video game device includes:
first game process means for performing the first game process using the first save data; and
second game process means for performing the second game process using the second save data;
first overwriting means for overwriting the first save data based on a status of the second video game; and
second overwriting means for overwriting the second save data based on a status of the first video game.

9. A storage medium storing a video game program to be executed by a computer of a video game device for performing a first game process, the video game device being capable of receiving both the storage medium and another storage medium at the same time, wherein:
the storage medium includes:
first program storage means for storing the video game program; and
first save data storage means for storing first save data regarding a first video game played by performing the first game process;
the other storage medium includes:
second program storage means for pre-storing another video game program used for performing a second game process; and
second save data storage means for storing second save data regarding a second video game played by performing the second game process;
the video game device includes second game process means for performing the second game process using the second save data; and
the video game program instructs the computer to perform:
a first game process step of performing the first game process using the first save data;
a first overwriting step of overwriting the first save data based on a status of the second video game; and
a second overwriting step for overwriting the second save data based on a status of the first video game.
